(19) United States
(12) Patent Application Publication
(10) Pub. No.: US 2020/0384631 A1
(43) Pub. Date: Dec. 10, 2020

(54) Modular Tool Holder And Storage System

(71) Applicant: Think & Tinker, Ltd, Palmer Lake, CO (US)

(72) Inventors: Ronald Glenn Reed, Monument, CO (US); Michael Holmes Reed, Wellington, CO (US)

(73) Assignee: Think & Tinker, Ltd, Palmer Lake, CO (US)

(21) Appl. No.: 16/893,609

(22) Filed: Jun. 5, 2020

Related U.S. Application Data
(60) Provisional application No. 62/858,841, filed on Jun. 7, 2019.

(51) Int. Cl. B25H 3/00; B25H 3/02

(52) U.S. Cl. CPC B25H 3/003; B25H 3/026

(57) ABSTRACT

An apparatus including a channel having open channel ends, a pair of channel sidewalls extending from a channel web, and a pair of linear ribs inwardly protruding from the pair of channel sidewalls, the pair of ribs configured to slidably engage a pair of grooves disposed in a tool holder.

This United States Non-Provisional Patent Application claims the benefit of U.S. Provisional Patent Application No. 62/858,841, filed Jun. 7, 2019, hereby incorporated by reference herein.

### I. FIELD OF THE INVENTION

Generally, a modular tool holder and storage system. Specifically, a modular tool holder including an open ended channel having one or more linear ribs inwardly protruding from a pair of channel sidewalls to slidably engage a corresponding one or more grooves disposed in a tool holder to allow one or more tool holders to be slidably retained within an interior channel space of said open ended channel.

### II. SUMMARY OF THE INVENTION

Accordingly, a broad object of the present invention is to provide an apparatus including one or more of a channel having a length disposed between open channel ends, the channel including a pair of channel sidewalls disposed in opposite parallel spaced apart relation outwardly extending from a channel web, and one or more linear ribs inwardly protruding in opposite parallel spaced relation from the pair of channel sidewalls and extending between the open channel ends, the pair of ribs configured to slidingly engage one or more grooves disposed in a tool holder.

Another broad object of the present invention is to provide a method of making an apparatus including one or more of configuring a channel to have a length disposed between open channel ends, said channel including a pair of channel sidewalls disposed in opposite parallel spaced apart relation outwardly extending from a channel web, and disposing at least one rib inwardly protruding from one of the pair of channel sidewalls and extending between the open first channel ends, the at least one rib configured to slidingly engage at least one groove disposed in a tool holder.

Another broad object of the present invention is to provide a method of using an apparatus including one or more of obtaining an apparatus including one or more of a channel having a length disposed between open channel ends, the channel including a pair of channel sidewalls disposed in opposite parallel spaced apart relation outwardly extending from a channel web, and a at least one linear ribs inwardly protruding from one of the pair of channel sidewalls and extending between the open channel ends, the at least one rib configured to slidingly engage at least one groove disposed in a tool holder, obtaining a tool holder including one or more of a pair of tool holder sides disposed in opposite parallel spaced apart relation defining a tool holder width slidably disposed between the pair of channel sidewalls, at least one spacer groove correspondingly disposed in the pair of tool holder sides, the at least one groove configured to slidingly receive the at least one rib to retain the tool holder within the channel, and slidingly engaging the tool holder to the channel.

Naturally, further objects of the invention are disclosed throughout other areas of the specification, drawings, photographs, and claims.

### III. A BRIEF DESCRIPTION OF THE DRAWINGS

FIG. 1 is a perspective view of a particular embodiment of a modular tool holder and storage system.

FIG. 2A is an exploded perspective view of a particular embodiment of a modular tool holder and storage system.

FIG. 2B is an enlarged perspective view of FIG. 2A of a particular embodiment of a modular tool holder and storage system.

FIG. 3 is a perspective view of a particular embodiment of a tool holder sleeve disengaged from a particular embodiment of a tool holder having a tool disposed therein.

FIG. 4 is a perspective view of a particular embodiment of a channel.

FIG. 5 is a front elevation view of a particular embodiment of a channel.

FIG. 6 is a back elevation view of a particular embodiment of a channel.

FIG. 7 is a side elevation view of a particular embodiment of a channel.

FIG. 8 is another side elevation view of a particular embodiment of a channel.

FIG. 9 is a top plan view of a particular embodiment of a channel.

FIG. 10 is a bottom plan view of a particular embodiment of a channel.

FIG. 11 is a perspective view of a particular embodiment of a tool holder.

FIG. 12 is a front elevation view of a particular embodiment of a tool holder.

FIG. 13 is a back elevation view of a particular embodiment of a tool holder.

FIG. 14 is a side elevation view of a particular embodiment of a tool holder.

FIG. 15 is another side elevation view of a particular embodiment of a tool holder.

FIG. 16 is a top plan view of a particular embodiment of a tool holder.

FIG. 17 is a bottom plan view of a particular embodiment of a tool holder.

FIG. 18 is a perspective view of a particular embodiment of a spacer element.

FIG. 19 is a front elevation view of a particular embodiment of a spacer element.

FIG. 20 is a back elevation view of a particular embodiment of a spacer element.

FIG. 21 is a side elevation view of a particular embodiment of a spacer element.

FIG. 22 is another side elevation view of a particular embodiment of a spacer element.

FIG. 23 is a top plan view of a particular embodiment of a spacer element.

FIG. 24 is a bottom plan view of a particular embodiment of a spacer element.

FIG. 25 is a perspective view of a particular embodiment of an end cap.

FIG. 26 is a front elevation view of a particular embodiment of an end cap.

FIG. 27 is a back elevation view of a particular embodiment of an end cap.

FIG. 28 is a side elevation view of a particular embodiment of an end cap.

FIG. 29 is another side elevation view of a particular embodiment of an end cap.

FIG. 30 is a top plan view of a particular embodiment of an end cap.

FIG. 31 is a bottom plan view of a particular embodiment of an end cap.

FIG. 32 is a perspective view of a particular embodiment of a modular tool holder and storage system including a support structure.

FIG. 33A is a perspective view of another particular embodiment of a modular tool holder and storage system including a support structure.

FIG. 33B is an enlarged view of FIG. 33A of another particular embodiment of a modular tool holder and storage system including a support structure.

### IV. DETAILED DESCRIPTION OF THE PREFERRED EMBODIMENTS

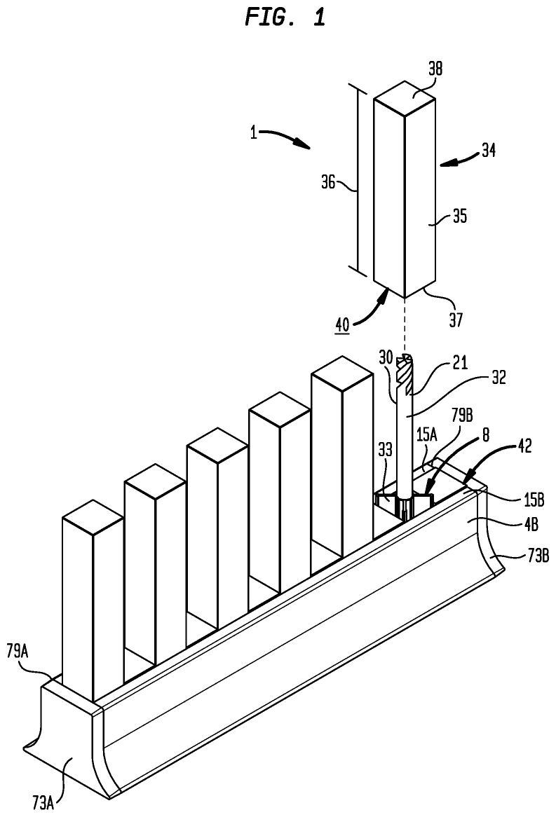

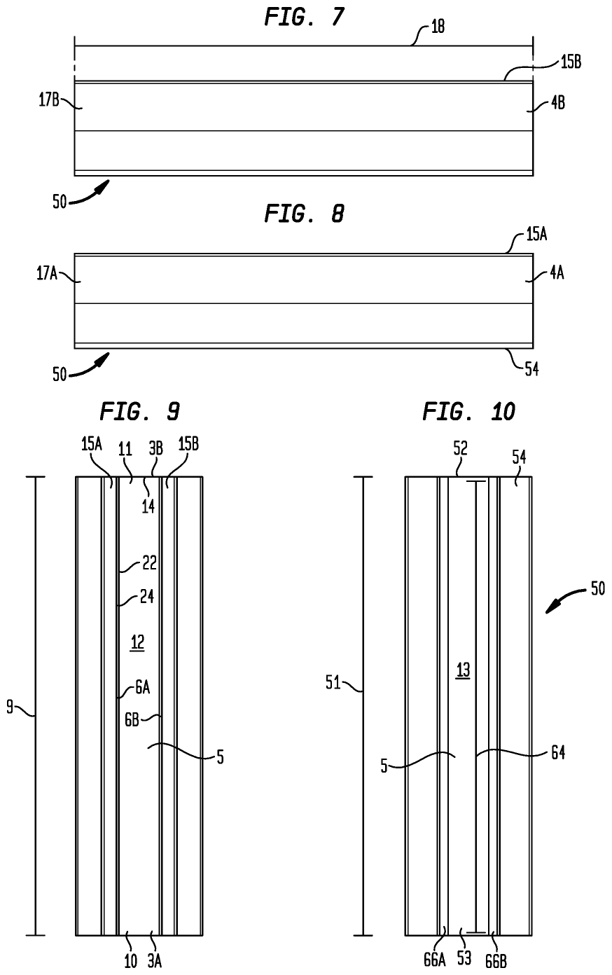

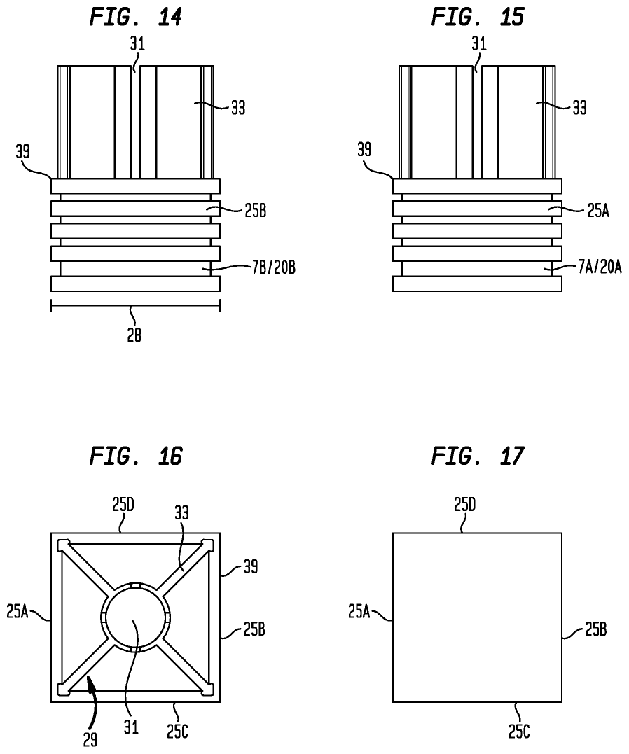

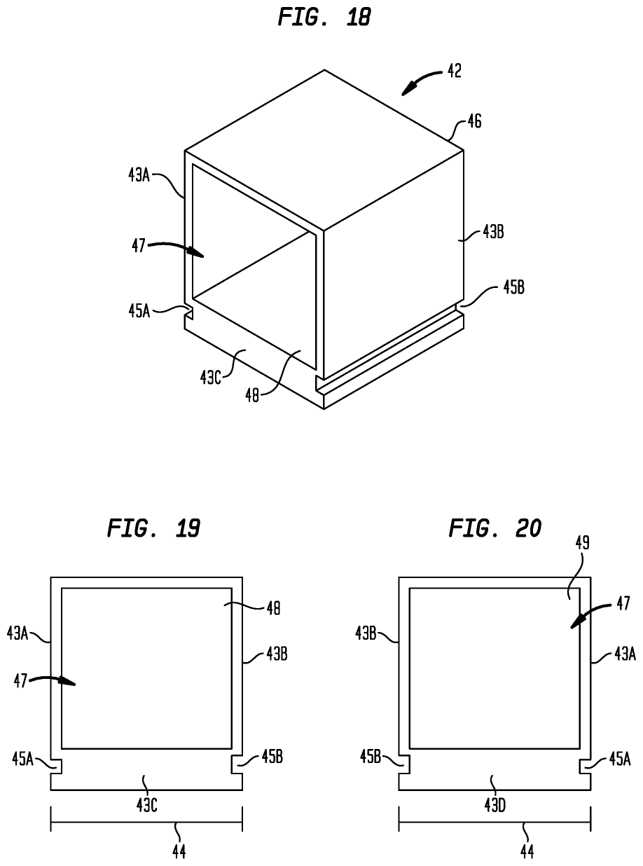

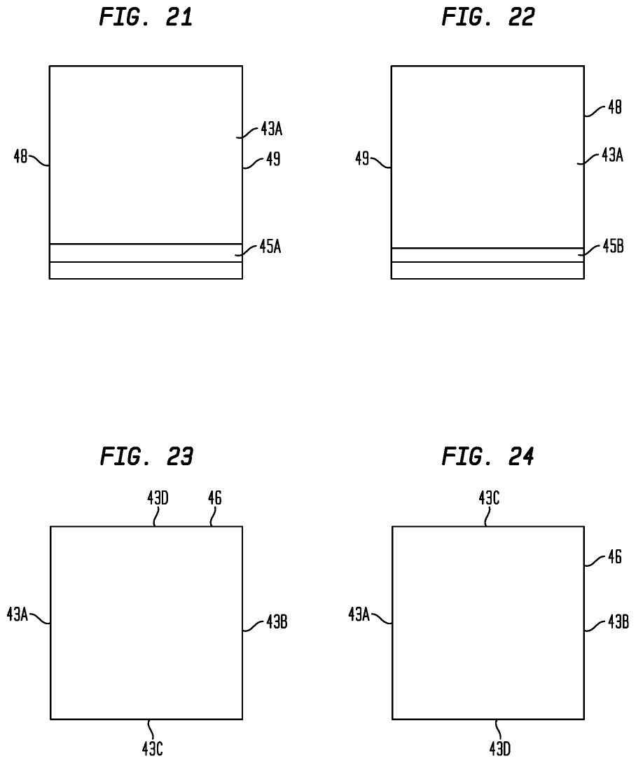

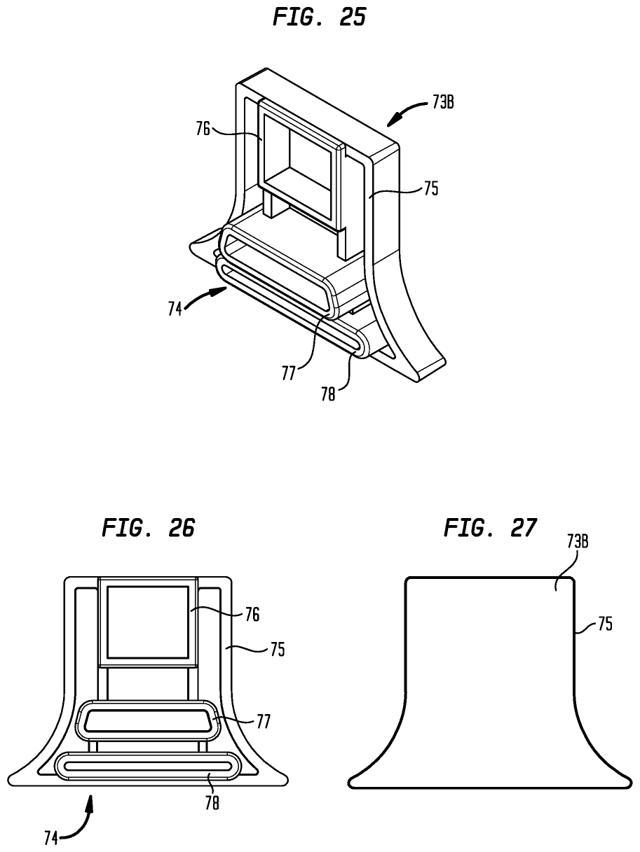

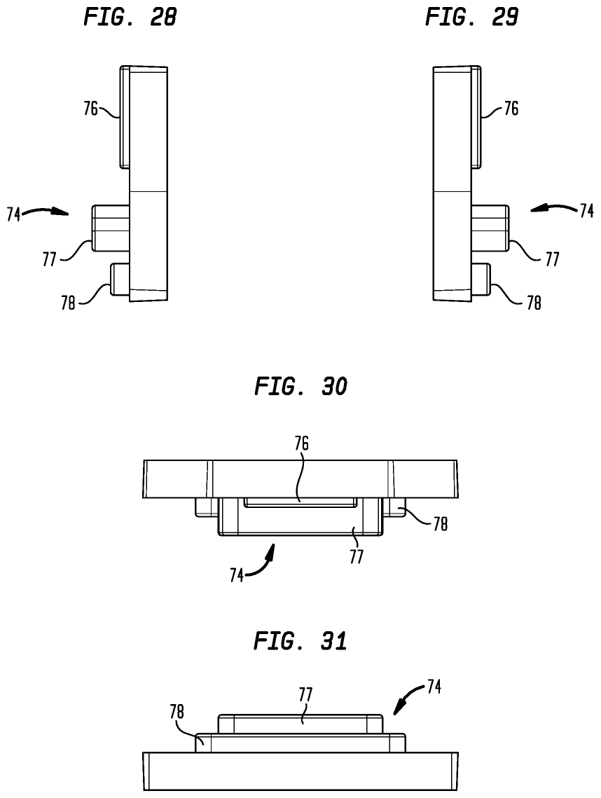

Generally, with reference to FIGS. 1-33B, embodiments of a modular tool holder and storage system (1) can include a channel (2) having open channel ends (3A)(3B), the channel (2) including a pair of channel sidewalls (4A)(4B) disposed in opposite parallel spatially fixed relation outwardly extending from a channel web (5), and at least one or a pair of linear ribs (6A)(6B) disposed in opposite inwardly protruding parallel spatially fixed relation from the pair of channel sidewalls (4A)(4B) and extending between the open channel ends (3A)(3B), the at least one or the pair of ribs (6A)(6B) configured to slidingly engage at least one or a pair of grooves (7A)(7B) disposed in a tool holder (8).

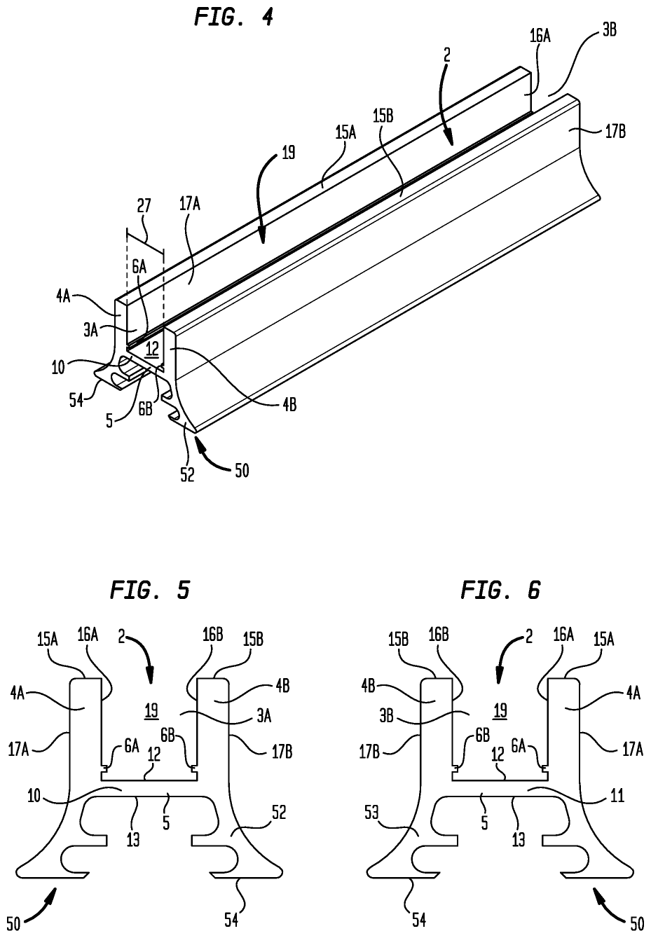

Now referring primarily to FIGS. 4 through 10, particular embodiments of a modular tool holder and storage system (1) can include a channel (2). The channel (2) can be defined by a channel web (5) and a pair of channel sidewalls (4A)(4B). The channel web (5) can have a channel web length (9) disposed between a channel web first end (10) and a channel web second end (11). The channel web (5) can have a channel web first side (12) disposed opposite a channel web second side (13). The channel web first and second sides (12)(13) can each extend to a channel web periphery (14) joining the channel web first and second sides (12)(13). In particular embodiments, the channel web first and second sides (12)(13) can, but need not necessarily, be flat; provided that, embodiments of the channel web first or second side (12)(13) can be arcuate, or include one or more patterned surface elements such as grooves, protuberances, or textures, or provide smooth or polished surfaces, or combinations thereof.

Again, referring primarily to FIGS. 4 through 10, a pair of channel sidewalls (4A)(4B) can be coupled or connected in opposite parallel spatially fixed relation to the channel web first side (12). Each of the pair of channel sidewalls (4A)(4B) can outwardly extend a distance from the channel web (5) to a channel side wall terminal edge (15A)(15B) joining a channel sidewall interior side (16) and a channel sidewall exterior side (17). In particular embodiments, each of the pair of channel sidewall interior sides (16A)(16B) can be disposed in orthogonal relation to the channel web first side (12); however, this is not intended to preclude embodiments in which the one or both of the channel sidewall interior sides (16A)(16B) can extend at an angle from the channel web first side (12), whether inwardly or outwardly from the other. Each of the pair of channel sidewalls (4A)(4B) can, but need not necessarily, extend the entire channel length (18) of the channel web (5). The channel web first side (12) and the pair of channel sidewall interior sides (16A)(16B) can define a channel interior space (19). In particular embodiments, the channel (2) can have channel first or second ends (3A)(3B) open proximate corresponding channel web first or second ends (10)(11).

Again, referring primarily to FIGS. 4 through 10, particular embodiments of the channel (2) can, but need not necessarily, include a first or a second linear rib (6A)(6B) or a pair of linear ribs (6A)(6B). Each of the first or second linear rib (6A)(6B) or pair of linear ribs (6A)(6B) can be correspondingly coupled to one of the pair of channel sidewalls (4A)(4B). Each of the first or second rib (6A)(6B) can inwardly protrude from a corresponding one of the pair of channel sidewalls (4A)(4B) or a pair of linear ribs (6A)(6B) can inwardly protrude in parallel opposite spaced apart relation from the pair of channel sidewalls (4A)(4B) into the channel interior space (19). In particular embodiments, the pair of ribs (6A)(6B) can be disposed in parallel opposite aligned spaced apart relation. Each of the pair of linear ribs (6A)(6B) can extend between the open channel ends (3A)(3B). In particular embodiments, the pair of linear ribs (6A)(6B) can extend the entire channel length (18) or extend only a portion thereof. In particular embodiments including more than one rib (6A), the plurality of ribs (6A)(6B)(6 . . . ) can be of substantially the same or substantially different configurations.

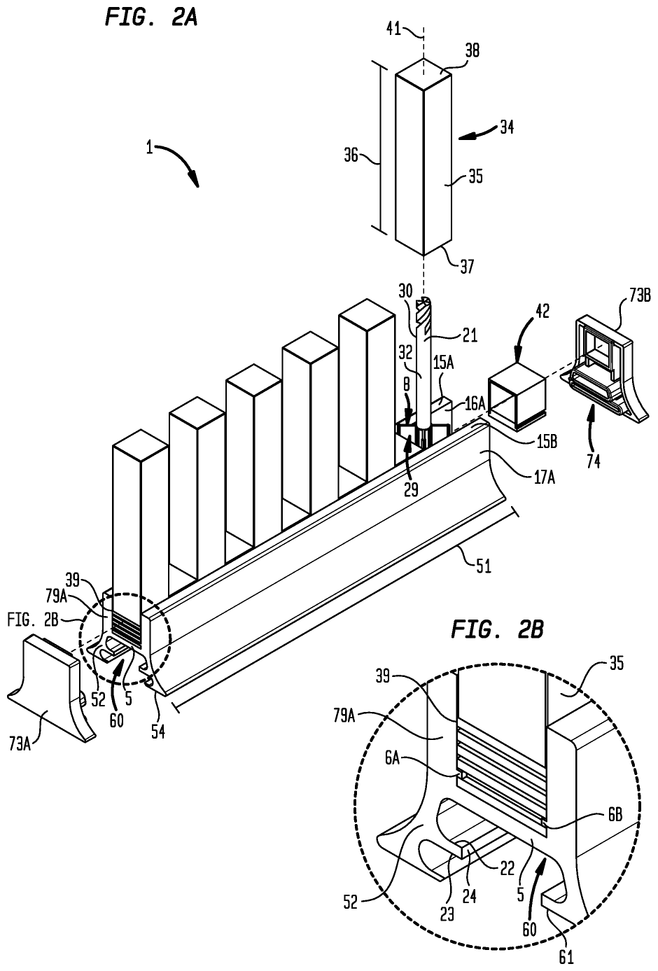

Now, referring primarily to FIGS. 1 and 2, the first or second rib (6A)(6B) or the pair of ribs (6A)(6B) or greater number of ribs (6A)(6B)(6 . . . ) can be configured to correspondingly slidingly engage a holder first groove (20A), a holder second groove (20B), a holder pair of grooves (20A)(20B) or a greater number of holder grooves (20A)(20B)(20 . . . ) disposed in a tool holder (8) which can be configured to retain, hold, or carry a tool (21). The term “tool (21)” broadly encompasses any type of device or implement, and without sacrificing the breadth of the foregoing, includes devices or implements having a shank which may vary in configuration and as illustrative examples may be a circular or straight shank, a triangular shank, a square shank, a hexagonal shank, a brace shank, an SDS shank, a threaded shank which supports a bit or bit assembly including cutting edges, and as illustrative examples, includes router bits, drill bits, spade bits, twist bits, brad point bits, masonry bits, tile bits, and countersink bits, rotary tool attachments, screwdrivers, scissors, brushes, keys, or combinations thereof, and while the illustrative examples shown in the Figures show a spiral flute router bit; this is not intended to preclude embodiments of tools that can be disposed in corresponding embodiments of the tool holder (8).

Again, referring to FIGS. 4 through 10, in particular embodiments each of the pair of ribs (6A)(6B) can, but need not necessarily, include a first rib face (22) opposite a second rib face (23) joined by a terminal rib periphery (24); and while each of the pair of ribs (6A)(6B) shown in the Figures includes a first rib face (22), a second rib face (23), and a terminal rib periphery (24) each being substantially flat; this is not intended to preclude any configuration of a first rib (6A), a second rib (6B), a pair of ribs (6A)(6B), or a greater number of ribs, configured to be slidingly engaged by a tool holder (8). In particular embodiments, the terminal rib periphery (24), first rib face (22), or second rib face (23), or combinations thereof, can be arcuate or rounded, or in particular embodiments each rib (6A) can include only a first rib face (22) opposite a second rib face (23) inwardly tapering to terminal apex. However, these illustrative examples are not meant to limit or preclude any of various configurations of the first rib (6A), the second rib (6B), the pair of ribs (6A)(6B), or a greater number of ribs (6A)(6B)(6 . . . ) which can slidingly engage the corresponding grooves (20A)(20B)(20 . . . ) of a tool holder (8).

Now referring primarily to FIGS. 1 through 3 and 11 through 17, particular embodiments of the modular tool holder and storage system (1) can include a tool holder (8). The tool holder (8) can include a pair of tool holder sides (25A)(25B) disposed in opposite fixed spatial relation defining a tool holder width (26) lesser than the channel width (27) disposed between the channel sidewall interior sides (16A)(16B) allowing the tool holder (8) to be slidably disposed between the pair of channel sidewalls (4A)(4B). While the particular embodiment of the tool holder (8) shown in the Figures includes four tool holder sides (25A)(25B)(25C)(25D), this is not intended to preclude embodiments of the tool holder (8) having three tool holder sides, five tool holder sides, six tool holder sides, or even a greater number of sides, or tool holders (8) having circular, oval, oblong or otherwise which can include a first groove (20A), a second groove (20B), or a pair of grooves (20A)(20B) which can receive a corresponding first rib (6A), second rib (6B), pair of ribs (6A)(6B) or a greater number of ribs (6A)(6B)(6 . . . ).

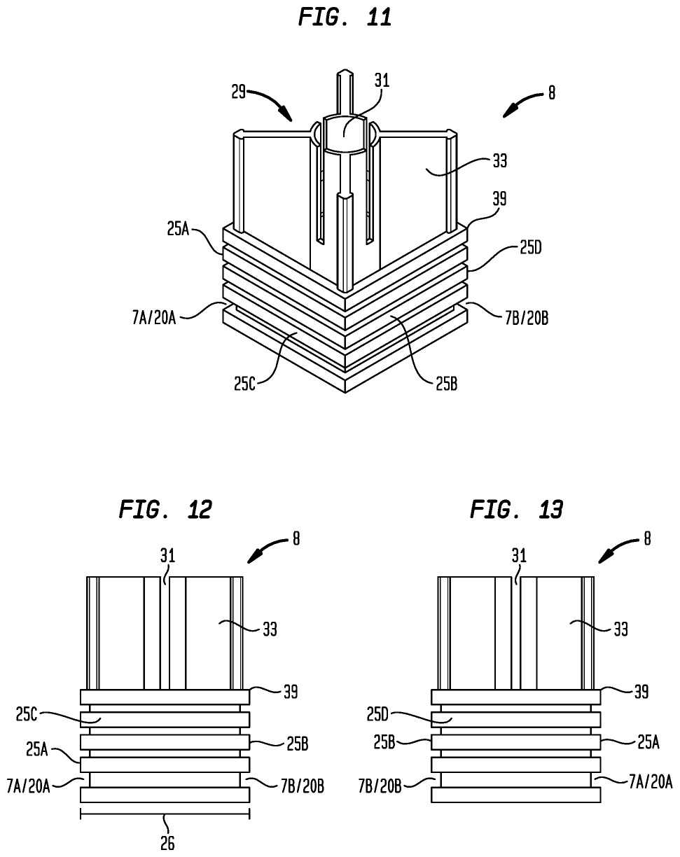

As shown in the illustrative examples of FIGS. 11 through 17, the tool holder (8) can further include a holder first groove (20A) or a holder second groove (20B) or a pair of holder grooves (20A)(20B) correspondingly disposed in a tool holder first side (25A), a tool holder second side (25B) or in a corresponding one of the pair of tool holder sides (25A)(25B). In particular embodiments, the first rib (6A), the second rib (6B), or each of the pair of ribs (6A)(6B) coupled to the pair of channel sidewalls (4A)(4B) can be configured to be slidingly received in the corresponding holder first groove (20A) of the tool holder first side (25A) or the holder second groove (20B) of the tool holder second side (25B) or each of the pair of holder grooves (20A)(20B) to slidingly retain the tool holder (8) within the channel (2). In particular embodiments, the tool holder (8) can include a second pair of tool holder sides (25C)(25D). The second pair of tool holder sides (25C)(25D) can, but need not necessarily, define a tool holder length (28) which can, but need not necessarily be, of lesser dimension than the channel width (27) of the channel (2). In the example illustrated in FIGS. 11 through 17, the embodiment includes congruent first and second pairs of tool holder sides (25A)(25B)(25C)(25D). In this configuration, a circumferential, continuous groove can extend about the tool holder first and second pairs of tool holder sides (25A)(25B)(25C)(25D) allowing sliding engagement of each pair of tool holder sides (25A)(25B) or (25C)(25D) with a first rib (6A), a second rib (6B) or a pair of ribs (6A)(6B). However, these illustrative embodiments are not meant to be limiting with respect to other slidably matable configurations of the rib (6A).

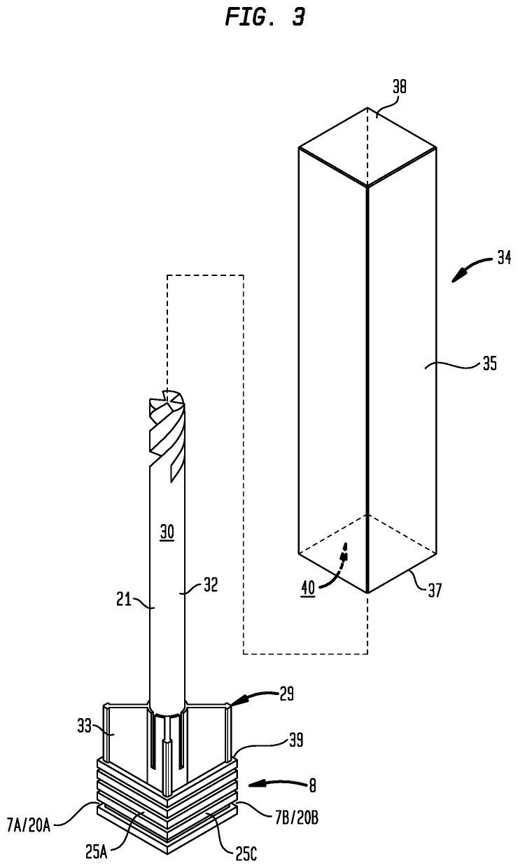

Again, referring primarily to FIGS. 11 through 17, in particular embodiments a tool retention element (29) configured to hold a tool (21) can be disposed in the tool holder (8). As an illustrative example of FIG. 3, the tool retention element (29) can afford a cavity, socket or recess which matingly engages a tool external surface (30) to retain or hold the tool (21) in the tool holder (8). In the illustrative example of FIG. 3, the tool holder (8) includes a tool retention element (29) configured as a tubular socket (31) which matingly engages a correspondingly configured cylindrical portion of a shank (32) of a tool (21) having tool external surface (30). However, this illustrative example of the tool retention element (29) is not intended to preclude embodiments of the tool retention element (29) configured to matingly engage other configurations of the tool external surface (30) including, posts outwardly extending from the tool holder to fit within a tubular recess of a tool, or snap-fit features including as examples: one or more of hoop-strain, cantilever, torsional, or other snap-fit features, or interference fit including as examples: press fit, or friction fit features. As shown in the example of FIG. 3, the tool retention element (29) can be supported at a central location within the tool holder (8) by a plurality of circumferentially disposed support walls (33) joining the tubular socket (31) to the first and second pairs of tool holder sides (25A)(25B)(25C)(25D).

Now referring to FIGS. 1 through 3, particular embodiments of the tool holder (8) can, but need not necessarily, include a tool holder sleeve (34). In particular embodiments, the tool holder sleeve (34) can include a tubular body (35) having a tubular body length (36) disposed between a tubular body first end (37) and a tubular body second end (38). The tubular body first end (37) can afford an open tubular body first end (37) which can be configured to matingly engage the tool holder periphery (39). The tubular body second end (38) can afford either an open or closed tubular body second end (38). The tubular body (35) can define a tubular body interior space (40) extending between the tubular body first end (37) and tubular body second end (38).

The tubular body interior space (40) can be configured to matingly engage the tool holder periphery (39) to surround or enclose tools (21) received in the tool retention element (29) of the tool holder (8). In particular embodiments, the tubular body (35) can define a rectangular volume; however, this is not intended to preclude a tubular body (35) defining a circular, hexagonal, square, rectangle, octagonal, or other cross-sectional configuration. In further particular embodiments, the tubular body interior space (40) can have various cross-sectional shapes along the tubular body length (36) of the tubular body (35). In particular embodiments, the tubular body length (36) of the tubular body (35) can receive, surround, or enclose the entirety of the tool (21) received in the tool holder (8), or receive, surround, or enclose a portion of the tool (21) received in the tool holder (8). In the illustrative example of FIGS. 1 through 3, the tool holder sleeve (34) has an open tubular body first end (37), a closed tubular body second end (38), and a tubular body interior space (40) configured to have a square cross-section orthogonal to the longitudinal axis (41) of the tool holder sleeve (34). The open tubular body first end (37) can matingly engage the square tool holder periphery (39). Upon mating engagement of the open tubular body first end (37) with the tool holder periphery (39), the tool (21) can reside within the tubular body interior space (40) of the tool holder sleeve (34).

Now referring primarily to FIGS. 1 through 3 and 18 through 24, particular embodiments of the modular tool holder and storage system (1) can include a spacer element (42). The spacer element (42) can include a first pair of spacer element sides (43A)(43B) disposed in opposite spatially fixed relation defining a spacer element width (44) lesser than the channel width (27) between the channel sidewall interior sides (16A)(16B) allowing the spacer element (42) to be slidably disposed between the pair of channel sidewalls (4A)(4B). In particular embodiments, the spacer element width (44) can, but need not necessarily, substantially correspond to the channel width (27) of the channel (2). Depending upon the embodiment, the spacer element (42) can, but need not necessarily, further include a first spacer groove (45A), a second spacer groove (45B), or a pair of spacer grooves (45A)(45B) configured to correspondingly slidingly receive the first rib (6A), the second rib (6B) or the pair of ribs (6A)(6B) disposed on the channel sidewalls (4A)(4B) to retain the spacer element (42) within the channel (2). The spacer element (42) can have various configurations including a first pair of spacer element sides (43A)(43B). In particular embodiments, the configuration can include a second pair of spacer element sides (43C)(43D) disposed in opposite spaced apart relation to define a square or rectangle spacer periphery (46). In further particular embodiments, the configuration can include a plurality of pairs of spacer element sides (43A)(43B)(43C)(43D)(43 . . . ) disposed in opposite spaced apart relation, including a hexagonal or octagonal configuration or even a spacer side defining a circular or oval configuration. While the embodiment of the spacer element (42) shown in FIGS. 18 through 24 can include a pair of spacer grooves (45A)(45B) correspondingly disposed in a pair of spacer element sides (43A)(43B) disposed in opposite relation; this illustrative example is not intended to preclude other embodiments of the spacer element (42) having only a first spacer groove (45A) or a second spacer groove (45B) or a plurality of spacer grooves (45A)(45B)(45 . . . ) configured to receive a corresponding configuration of ribs (6A)(6B)(6 . . . ) coupled to a channel sidewall (4A).

Again, referring primarily to FIGS. 18 through 24, the spacer element (42) can include a spacer element body (47). The spacer element body (47) can have a spacer element body first end (48) coupled to the first pair of spacer element sides (43A)(43B), the plurality of spacer element sides (43A)(43B)(43C)(43D), or a combination thereof. The spacer element body (47) can extend a distance outwardly from the spacer element body first end (48) to a spacer element body second end (49). The spacer element body (47) can afford a solid spacer element body (47), a tubular spacer element body (47), or a combination thereof.

Again, referring primarily to FIGS. 4 through 6, particular embodiments of the modular tool holder and storage system (1) can, but need not necessarily, include a base (50) coupled to the channel (2). In particular embodiments, the base (50) can be solid, tubular, or a combination of both. In particular embodiments, the base (50) can be coupled to the channel web second side (13). The base (50) can have a length (51) disposed between a base first end (52) and a base second end (53). The length (51) of the base (50) can be less than, substantially equal to, or longer than the channel length (18). The base (50) can extend a distance from the channel web second side (13) to terminate in a base external surface (54).

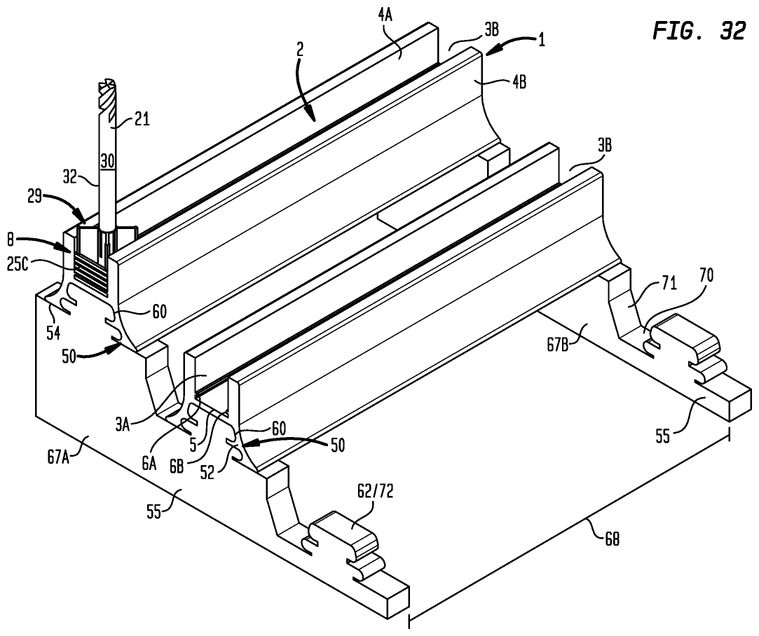

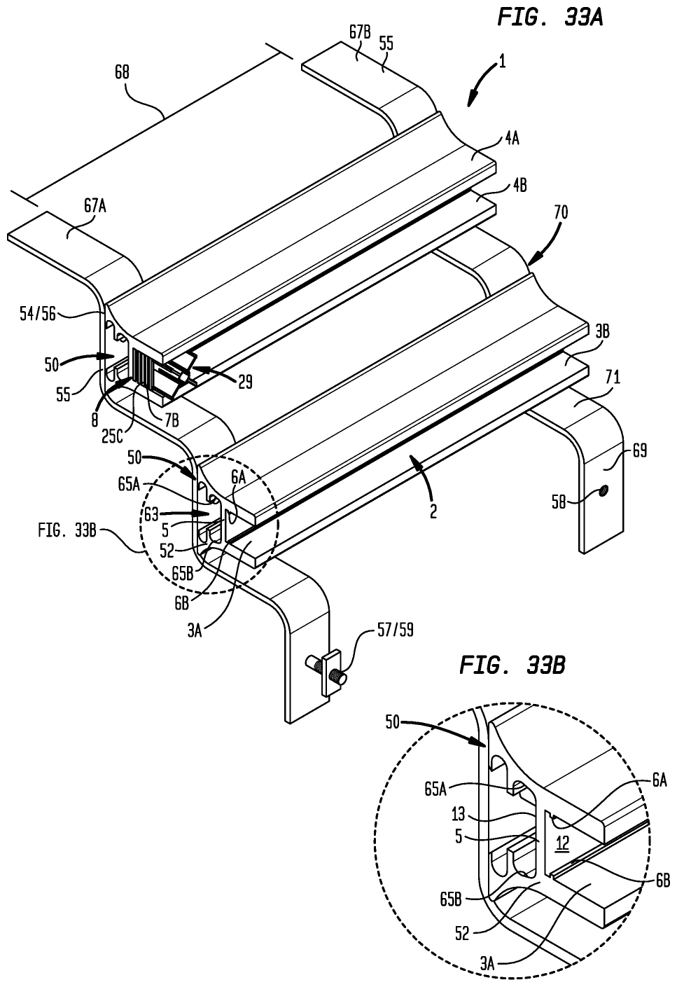

Now, referring primarily to FIGS. 32, 33, and 33A, in particular embodiments the base external surface (54) can be configured to engage a support structure (55) (as shown in the example of FIG. 33) to dispose the channel (2) in an orientation to receive one or more tool holders (8) or spacer elements (42) or combinations thereof within the channel (2). The base external surface (54) can include one or more flat base surfaces (56) to correspondingly engage a substantially flat support structure (55) (as shown in the example of FIG. 33). The one or more flat base surfaces (56) can be configured to fasten to one or more of the flat support structures (55). In particular embodiments, the base (50) can include threaded fastening elements (57) capable of matingly engaging threaded annular members (58) disposed on the support structure (55). In other particular embodiments, the base (50) can include threaded annular members (58) disposed on the base external surface (54) capable of matingly engaging threaded fastening elements (57). In other particular embodiments, the base (50) can be fastened to the support structure (55) by mechanical fastening elements (59) including, but not limited to, nails, brads, staples, or other like mechanical fastening elements (59). In yet further particular embodiments, the base external surface (54) can be fastened to the support structure (55) using an adhesive.

Now referring to FIG. 32, particular embodiments of the base (50) can further include a base mount recess (60). The base mount recess (60) can, but need not necessarily, extend between the base first end (52) and the base second end (53). The base mount recess (60) can include a base recess surface (61). The base recess surface (61) can be configured to matingly receive a protruding support element (62). The protruding support element (62) can be disposed on the support structure (55).

Now referring primarily to FIGS. 4 through 6 and 32, particular embodiments of the base (50) can further include a base channel (63). The base channel (63) can have a base channel length (64) extending from the base first end (52) to the base second end (53), or a portion thereof. The base channel (63) can include a pair of base channel sidewalls (65A)(65B) disposed in opposed spaced apart relation outwardly extending from the channel web (5). In further particular embodiments, the base channel (63) can further include a pair of base retaining members (66A)(66B). The pair of base retaining members (66A)(66B) can correspondingly inwardly extend in opposed relation from the pair of base channel sidewalls (65A)(65B) and can extend along the length channel length (18). In particular embodiments, the base channel (63) and pair of retaining members (66A)(66B) can matingly engage a protruding support element (62).

Again referring primarily to FIGS. 32, 33, and 33A, particular embodiments of a support structure (55) can include a pair of support structure members (67A)(67B). The pair of support structure members (67A)(67B) can be substantially flat. The pair of support structure members (67A)(67B) can be spaced in opposite parallel relation a distance apart. The distance (68) between the pair of support structure members (67A)(67B) can be substantially equal to or less than the channel length (18). The base external surface (54) can include one or more flat base faces (56) corresponding to each of the pair of support structure members (67A)(67B). The one or more flat base faces (56) can be fastened to the corresponding flat support faces (69) of the pair of support structure members (67A)(67B). In particular embodiments, the base (50) can include threaded fastening elements (57) capable of matingly engaging threaded annular members (58) disposed on the pair of support structure members (67A)(67B). In other particular embodiments, the base (50) can include threaded annular members (58) disposed on the base external surface (54) capable of matingly engaging threaded fastening elements (57). In other particular embodiments, the base (50) can be fastened to the pair of support structure members (67A)(67B) by mechanical fastening elements (59) including, but not limited to, nails, brads, staples, or other like mechanical fastening elements (59). In yet further particular embodiments, the base external surface (54) can be fastened to the pair of support structure members (67A)(67B) using an adhesive.

Now referring primarily to FIGS. 32, 33, and 33A, the support structure (55) can include a plurality of tiered laterally offset faces (70). The faces (70) can be connected by riser panels (71) disposed at an angle from the faces (70). The faces (70) can be substantially flat or further include a protruding mount element (72) disposed on the faces (70) (as shown in the example of FIG. 33). One or more bases (50) can correspondingly be coupled to the faces (70) or protruding mount elements (72).

Now referring primarily to FIGS. 1 and 2 and FIGS. 25 through 31, particular embodiments of the modular tool holder and storage system (1) can, but need not necessarily, include a pair of end caps (73A)(73B). Each of the end caps (73A)(73B) can have a mating surface (74) configured to matingly engage a corresponding one of the open channel ends (3A)(3B) of the modular tool holder and storage system (1). In particular embodiments, the end cap peripheral edge (75) can be configured to overlap and provide an interference fit with the external surface of the channel sidewalls (4A)(4B) proximate the open channel ends (3A)(3B). In those embodiments having a base (50), the pair of end caps (73A)(73B) can be configured to overlap and provide an interference fit with the channel sidewalls external sides (17A)(17B). In particular embodiments, the mating surface (74) can include a first raised plateau (76) corresponding in cross-sectional configuration of the open channel ends (3A)(3B) to the channel interior space (19). In particular embodiments including a base (50) having a base mount recess (60) or a base channel (63), the mating surface (74) can include a second raised plateau (77) or a third raised plateau (78) corresponding in cross-sectional shape to the base mount recess (60) or base channel (63). The mating surface (74) can be aligned with the corresponding features of the channel (2) and base (50) and be matingly engaged. In the illustrated particular embodiment of FIGS. 5 and 6, the channel interior space (19) has a quadrilateral configuration. The base (50) has a base mount recess (60) and a pair of base retaining members (66A)(66B). The mating surface (74) of the end cap (73A) can be configured to include a first raised plateau (76) in a quadrilateral configuration disposed adjacent a second raised plateau (77) corresponding to the base mount recess (60) and a pair of base retaining members (66A)(66B). The end cap (73A) can be matingly engaged to the modular tool holder and storage system first or second end (79A)(79B) by forcefully urging the corresponding first raised plateau (76) and second raised plateau (77) into the channel interior space (19) and the base mount recess (60) respectively.

Particular methods of using a modular tool holder and storage system (1) as described above can include obtaining a modular tool holder and storage system (1) including a channel (2). One or more tool holders (8) or spacer elements (42) can be slidingly received in the channel (2). In particular methods, a tool (21) can be matingly received in one or more of the tool holders (8). In further particular methods, a tool holder sleeve (34) can be matingly engaged to the tool holder (8). In yet further particular methods, the modular tool holder and storage system (1) can further include a base (50). The base (50) can be coupled to the support structure (55).

As can be easily understood from the foregoing, the basic concepts of the present invention may be embodied in a variety of ways. The invention involves numerous and varied embodiments of an apparatus and methods for making and using such apparatuses including the best mode.

As such, the particular embodiments or elements of the invention disclosed by the description or shown in the figures or tables accompanying this application are not intended to be limiting, but rather illustrative of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “spacer” should be understood to encompass disclosure of the act of “spacing”—whether explicitly discussed or not—and, conversely, were there effectively disclosure of the act of “spacing”, such a disclosure should be understood to encompass disclosure of a “spacer” and even a “means for spacing” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in Merriam-Webster's Collegiate Dictionary, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the apparatuses herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An apparatus, comprising:
a channel having a length disposed between open channel ends, said channel including a pair of channel sidewalls disposed in opposite spaced apart relation outwardly extending from a channel web; and
at least one linear rib inwardly protruding from one of said pair of channel sidewalls and extending between said open channel ends, wherein said at least one rib configured to slidingly engage at least one groove disposed in a tool holder.

2. The apparatus of claim 1, wherein said tool holder includes a pair of tool holder sides disposed in opposite parallel spaced apart relation defining a tool holder width slidably disposed between said pair of channel sidewalls, said at least one groove disposed in one of said pair of tool holder sides, said at least one groove configured to slidingly receive said at least one rib inwardly protruding from one of said pair of channel sidewalls to retain said tool holder within said channel.

3. The apparatus of claim 2, wherein said at least one rib comprises a pair of linear ribs inwardly protruding in opposite parallel spaced relation from said pair of channel sidewalls and extending between said open first channel ends, and wherein said at least one groove comprises a pair of grooves correspondingly disposed in said pair of tool holder sides, said pair of grooves configured to slidingly receive said pair of ribs to retain said tool holder within said channel.

4. The apparatus of claim 1, wherein said tool holder including a recess disposed in one surface of said tool holder generally orthogonal to said pair of grooves, said recess configured to retain a tool.

5. The apparatus of claim 4, wherein said tool includes a shank slidingly received in said recess.

6. The apparatus of claim 5, wherein said tool comprises a router bit.

7. The apparatus of claim 6, further comprising a tool holder sleeve having a closed sleeve end and an open sleeve end, said open sleeve end configured to matingly engage said tool holder.

8. The apparatus of claim 1, further comprising a pair of end caps each having a mating surface configured to matingly engage a corresponding one of said open channel ends.

9. The apparatus of claim 1, further comprising a spacer element including:
a first pair of spacer element sides disposed in opposite spaced apart relation defining a spacer element width slidably disposed between said pair of channel sidewalls; and
at least one spacer groove correspondingly disposed in one of said pair of spacer element sides, said at least one spacer groove configured to slidingly receive said at least one rib to retain said spacer element within said channel.

10. The apparatus of claim 9, wherein said spacer element further includes a second pair of spacer element sides disposed in opposite spaced apart relation defining a spacer length, said spacer element positionable in said channel between an adjacent pair of tool holders.

11. The apparatus of claim 10, wherein said at least one rib comprises a pair of linear ribs inwardly protruding in opposite parallel spaced relation from said pair of channel sidewalk and extending between said open first channel ends, and wherein said at least one spacer groove comprises a pair of spacer grooves correspondingly disposed in said pair of spacer element sides, said pair of spacer grooves configured to slidingly receive said pair of ribs to retain said spacer within said channel.

12. The apparatus of claim 1, further comprising a base coupled to said channel, having a length disposed between opposite ends, said base having a base external surface configured to fasten to a support structure.

13. The apparatus of claim 12, wherein said base external surface includes one or more flat base faces configured to fasten to one or more flat support faces.

14. The apparatus of claim 13, wherein said one or more flat support faces comprises a plurality of tiered adjacent flat faces connected by a plurality of riser panels.

15. The apparatus of claim 1, further comprising a base coupled to said channel, said base including a base recess extending between opposite base ends, said base recess having a base recess surface configured to matingly receive a protruding support element of a support structure.

16. The apparatus of claim 15, wherein said protruding support element comprises a plurality of tiered laterally offset protruding support elements connected by riser panels.

17. The apparatus of claim 1, further comprising a base coupled to said channel, said base including:
a base channel having a length disposed between open base channel ends, said base channel including a pair of base channel sidewalls disposed in opposed spaced apart relation outwardly extending from said channel web;
a pair of retaining members correspondingly protruding inwardly from said pair base channel sidewalls and extending between open base channel ends.

18. The apparatus of claim 17, further comprising a securement element configured to slidingly mateably engage said base channel.

19-26. (canceled)
